(19) United States
(12) Patent Application Publication
(10) Pub. No.: US 2024/0365777 A1
(43) Pub. Date: Nov. 7, 2024

(54) SYSTEMS AND METHODS FOR THAWING POLLEN

(71) Applicant: Monsanto Technology LLC, St. Louis, MO (US)

(72) Inventors: Eric L. Borrowman, St. Peters, MO (US); Zachary Boyer, Fenton, MO (US)

(21) Appl. No.: 18/648,874

(22) Filed: Apr. 29, 2024

Related U.S. Application Data
(60) Provisional application No. 63/499,303, filed on May 1, 2023.

(51) Int. Cl. A01N 3/00

(52) U.S. Cl. CPC A01N 3/00

(57) ABSTRACT

The present disclosure provides novel systems and methods for rapidly thawing cryopreserved pollen samples. The methods provided herein include methods of rapidly thawing cryopreserved pollen or bulk pollen samples having a desired moisture content, and methods of applying the rapidly thawed pollen to at least a recipient plant, thereby pollinating the recipient plant with the rapidly thawed pollen from the donor plant.

### CROSS-REFERENCE TO RELATED APPLICATIONS

This application claims the benefit under 35 U.S.C. § 119(e) of U.S. provisional application Ser. No. 63/499,303, filed on May 1, 2023, which is herein incorporated by reference in its entirety.

### FIELD OF THE INVENTION

The present disclosure relates to the field of agricultural biotechnology, and more specifically to systems and methods for rapidly thawing cryopreserved pollen.

### BACKGROUND OF THE INVENTION

Pollen viability is influenced by environmental conditions and may decrease rapidly once shed. Methods to improve pollen viability and fertility following pollen cryopreservation and thawing would have significant value to the agricultural industry. Corn (Zea mays; also known as maize), rice (Oryza sativa), wheat (Triticum aestivum), and sorghum (Sorghum bicolor), which belong to the Poaceae family of plants, are examples of economically important agricultural crops in which breeding has been hampered by low efficiency procedures for thawing cryopreserved pollen after storage. Pollen of plants from the Poaceae family is classified as recalcitrant or desiccation sensitive. Other non-limiting examples of recalcitrant pollen include pollen from certain species in the Alismataceae, Amaranthaceae, Cactaceae, Chenopodiaceae, Cucurbitaceae, Anacardiaceae, Portulacaceae, Urticaceae, Lauraceae, Liliaceae, Iridaceae, Orchidaceae, Acanthaceae, and Caryophyllaceae families. The thawing of cryopreserved pollen after short-term or long-term storage from such crops would provide significant advancements over the current state of the art in the fields of breeding and hybrid seed production.

Thawing of bulk samples of pollen to obtain viable and fertile pollen has proven extremely difficult. While applying cryopreserved pollen directly from a vial to individual plants is acceptable in several small-scale applications (e.g., plant breeding), there is a need to develop systems capable of rapidly warming bulk samples of cryopreserved pollen for use in larger scale applications (e.g., seed production).

### SUMMARY

The present disclosure provides a system for thawing a cryopreserved pollen sample that subjects each pollen grain in the sample to a warming rate exceeding 5° C./min at all subzero temperatures traversed. In certain embodiments, the system comprises a first chamber to which the cryopreserved pollen sample is introduced and warmed. In some embodiments, the first chamber comprises a gas, preferably a warm gas, selected from air, nitrogen, oxygen, argon, helium, or a combination thereof, through which the cryopreserved pollen sample is passed through to convectively warm the cryopreserved pollen sample, creating a thawed pollen sample. In other embodiments the system further comprises a conveyance system capable of dispensing the cryopreserved pollen sample into the first chamber. In additional embodiments, the system further comprises a second chamber in fluid communication with the first chamber, wherein the cryopreserved pollen sample is pneumatically conveyed by the gas through the first chamber to the second chamber, where the pollen settles out of the flow of the gas. In yet other embodiments, the gas has been humidified to a level such that the moisture content of the cryopreserved pollen sample is maintained or increased during thawing.

In particular embodiments, the first chamber comprises a vessel containing a liquid, preferably a warm liquid, to which the cryopreserved pollen sample is introduced to conductively warm the cryopreserved pollen sample creating a thawed pollen sample. In certain embodiments, the liquid is an aqueous solution, organic solvent, or an emulsion. In some embodiments, the first chamber comprises a metallic surface, preferably a warm metallic surface, to which the cryopreserved pollen sample is exposed to or conveyed across to conductively warm the sample, creating a thawed pollen sample.

In further embodiments, the first chamber comprises an inductive heating apparatus in which the cryopreserved pollen sample is mixed with an introduced ferromagnetic material and inductively warmed. In yet further embodiments, the first chamber comprises electromagnetic radiation to which the cryopreserved pollen sample is exposed to radiatively warm the cryopreserved pollen sample thereby creating a thawed pollen sample. In some embodiments, the electromagnetic radiation falls within the microwave or infrared wavelengths.

In other embodiments, the system further comprises a third container that maintains the cryopreserved pollen sample below the glass transition temperature prior to dispensing the cryopreserved pollen sample into the first chamber. In yet other embodiments, the third container comprises a feeding mechanism to meter the cryopreserved pollen sample into the first chamber. In certain embodiments, the feeding mechanism is a screw auger, vibratory feeder, positive displacement feeder, table feeder, belt feeder, or rotary feeder. In particular embodiments, the third container is cooled by dry ice, liquid nitrogen, a mechanical refrigeration system, or a cryocooler.

In some embodiments, the dry volume of the cryopreserved pollen sample is between about 1 ml and 500 liters. In other embodiments, the cryopreserved pollen is from a recalcitrant species. In yet other embodiments, the pollen is from a Poaceae family plant, an Alismataceae family plant, an Amaranthaceae family plant, a Cactaceae family plant, a Chenopodiaceae family plant, a Cucurbitaceae family plant, a Anacardiaceae family plant, a Portulacaceae family plant, a Urticaceae family plant, a Lauraceae family plant, a Liliaceae family plant, a Iridaceae family plant, a Orchidaceae family plant, a Acanthaceae family plant, or a Caryophyllaceae family plant. In still other embodiments, the pollen is corn, rice, wheat, or sorghum pollen. In another embodiment, the pollen is from a monocot plant.

In particular embodiments each grain of pollen in the cryopreserved pollen sample experiences a warming rate sufficient to prevent ice formation. In other embodiments each grain of pollen in the cryopreserved pollen sample experiences a warming rate exceeding 5° C./min, 6° C./min, 7° C./min, 8° C./min, 9° C./min or 10° C./min across all sub-zero temperatures traversed. In additional embodiments each grain of pollen in the cryopreserved pollen sample experiences a rapid increase in warming at a rate sufficient to prevent ice formation.

In further embodiments the thawed pollen sample has increased viability compared to a control cryopreserved pollen sample that experiences a warming rate insufficient to prevent ice formation. In yet other embodiments the thawed pollen sample has increased viability compared to a control cryopreserved pollen sample that experiences a warming rate less than 5° C./min, 6° C./min, 7° C./min, 8° C./min, 9° C./min or 10° C./min across all sub-zero temperatures traversed. In still other embodiments the viability of the thawed pollen sample can be maintained for durations of at least about 30 minutes, 1 hour, 2 hours, 4 hours, 8 hours, 12 hours, 24 hours, 48 hours, 72 hours, or 96 hours.

In certain embodiments the cryopreserved pollen sample is a cryopreserved bulk pollen sample. In some embodiments the dry volume of the cryopreserved pollen sample is between about 1 ml and about 500 liters. In particular embodiments, the dry volume of the cryopreserved pollen sample is about 1 ml, about 2 ml, about 3 ml, about 4 ml, about 5 ml, about 10 ml, about 25 ml, about 50 ml, about 75 ml, about 100 ml, about 250 ml, about 500 ml, about 750 ml, about 11, about 5 l, about 10 ml, about 25 l, about 50 l, about 100 l, about 150 l, about 200 l, about 250 l, about 300 l, about 350 l, about 400 l, about 450 l, or about 500 l. In additional embodiments, the dry volume of the cryopreserved pollen sample is between about 5 ml and about 500 liters, about 10 ml and about 500 liters, about 25 ml and about 500 liters, about 50 ml and about 500 liters, about 100 ml and about 500 liters, about 250 ml and about 500 liters, about 500 ml and about 500 liters, about 1 l and about 500 liters, about 5 l and about 500 liters, about 10 l and about 500 liters, about 501 and about 500 liters, about 1001 and about 500 liters, or about 2501 and about 500 liters, about 1 ml and about 250 liters, about 1 ml and about 100 liters, about 1 ml and about 50 liters, about 1 ml and about 10 liters, about 1 ml and about 5 liters, about 1 ml and about 1 liters, about 1 ml and about 750 ml, about 1 ml and about 500 ml, about 1 ml and about 250 ml, about 1 ml and about 100 ml, about 1 ml and about 50 ml, about 1 ml and about 25 ml, about 1 ml and about 10 ml, about 5 ml and about 250 liters, about 10 ml and about 100 liters, about 50 ml and about 50 liters, about 100 ml and about 10 liters, about 250 ml and about 5 liters, or about 500 ml and about 1 liter. In other embodiments the bulk cryopreserved pollen sample is capable of pollinating a plurality of plants. In yet other embodiments the bulk cryopreserved pollen sample is of a single genotype. In still other embodiments pollination with the thawed pollen sample results in at least 50% seed set. In some embodiments the bulk pollen samples are rapidly thawed.

In additional embodiments the moisture content of the cryopreserved pollen sample is between about 10% and 30% wet-basis moisture content. In certain embodiments the moisture content of the cryopreserved pollen sample is between about 17% and about 25% wet-basis moisture content. In some embodiments the moisture content of the cryopreserved pollen sample is between about 17% and about 20% wet-basis moisture content. In other embodiments the moisture content of the cryopreserved pollen sample is at least about 15% wet-basis moisture content, about 16% wet-basis moisture content, about 17% wet-basis moisture content, about 18% wet-basis moisture content, about 19% wet-basis moisture content, about 20% wet-basis moisture content, about 21% wet-basis moisture content, about 22% wet-basis moisture content, about 23% wet-basis moisture content, about 24% wet-basis moisture content, about 25% wet-basis moisture content, about 26% wet-basis moisture content, about 27% wet-basis moisture content, about 28% wet-basis moisture content, about 29% wet-basis moisture content, or about 30% wet-basis moisture content. In yet other embodiments the temperature of the cryopreserved pollen sample is below the glass transition temperature.

In one embodiment, the desired moisture content is a wet basis moisture content between about 10% and about 35%. The desired wet basis moisture content may be for example about 10%, 15%, 20%, 25%, 30%, or 35%, including all ranges derivable therebetween. In another embodiment, the desired moisture content is a dry basis moisture content between about 17% and about 55%. In yet another embodiment, the desired dry basis moisture content is between about 17.6% and about 53.8%. The desired dry basis moisture content may be for example about 17%, 20%, 25%, 30%, 35%, 40%, 45%, 50%, or 55%, including all ranges derivable therebetween.

In further embodiments the gas is air, nitrogen, oxygen or argon, or a combination thereof. In particular embodiments the gas is air. In some embodiments the moisture content of the gas is greater than the moisture content of the cryopreserved pollen sample. In further embodiments the gas has been humidified. In additional embodiments the cryopreserved pollen sample has been cryopreserved prior to thawing for at least about 4 days, 5 days, 6 days, 1 week, 2 weeks, 4 weeks, 8 weeks, 12 weeks, 20 weeks, 30 weeks, 40 weeks or a year. In other embodiments the cryopreserved pollen sample has been cryopreserved prior to thawing at about −80° C.

The present disclosure also provides a method of obtaining viable bulk pollen sample, comprising obtaining a cryopreserved bulk pollen sample, and rapidly thawing the bulk pollen sample, wherein each grain of pollen in the bulk pollen sample experiences a warming rate sufficient to prevent ice formation across all sub-freezing temperatures traversed. In some embodiments, the rapidly thawed bulk pollen sample has increased viability compared to a control bulk pollen sample that is not rapidly thawed. In certain embodiments each grain of pollen in the cryopreserved bulk pollen sample experiences a warming rate sufficient to prevent ice formation. In some embodiments, each grain of pollen in the cryopreserved bulk pollen sample experiences a warming rate of greater than 5° C./minute across all sub-freezing temperatures traversed. In other embodiments each grain of pollen in the cryopreserved bulk pollen sample experiences a warming rate of greater than 10° C./minute.

In particular embodiments the bulk pollen sample is thawed using convection, conduction, induction, or electromagnetic radiation, or a combination of one or more of convection, conduction, induction or electromagnetic radiation. In certain embodiments, the cryopreserved bulk pollen sample is warmed by convection with a gas or liquid. In some embodiments, the cryopreserved bulk pollen sample is warmed by conduction with a gas or liquid. In other embodiments, the cryopreserved bulk pollen sample is warmed by contact with an inductively heated material. In yet other embodiments, the cryopreserved bulk pollen sample is warmed by electromagnetic radiation in the microwave or infrared wavelengths. In still other embodiments, the cryopreserved bulk sample of pollen is warmed by a combination of convection with a gas or liquid, conduction with a gas or liquid, contact with an inductively heated material or electromagnetic radiation in the microwave or infrared wavelengths. In additional embodiments the method further comprises rapidly thawing a plurality of bulk pollen samples.

In some embodiments the method further comprises the step of pollinating a plant with the thawed pollen. In other embodiments the method further comprises pollinating a population of plants with the thawed pollen. In certain embodiments the pollinating results in at least 50% seed set.

### BRIEF DESCRIPTION OF DRAWINGS

Those of skill in the art will understand that the drawings, described below, are for illustrative purposes only. The drawings are not intended to limit the scope of the present teachings in any way.

FIG. 1 shows plots of mass-normalized heat flow versus temperature for corn pollen that had been dried to 25.8%, 21.1%, and 15.1% wet-basis moisture content, rapidly frozen to −150° C., and warmed at a rate of 10° C./min.

FIG. 2 shows a schematic of a cold vial containing pollen submerged in a warm water bath, with an exploded view of the vial containing the pollen, the wall of the vial and the water in the water bath.

FIG. 3A and FIG. 3B is a schematic showing exposure of an individual pollen grain to large temperature gradients either in the atmosphere (FIG. 3A) or in contact with the stigma surface (FIG. 3B).

FIG. 4 is a scatter plot of the resulting kernel number per ear from pollinations performed with pollen that was dried in three separate fluid bed dryers to wet-basis moisture contents of 11.7%, 17.5%, and 28.5%, frozen in polypropylene vials, and thawed either by immersion in a warm water bath or by directly apply pollen to the stigma.

FIG. 5A and FIG. 5B shows one embodiment of a convective thawing apparatus (FIG. 5A), and a scatter plot of kernel number per ear resulting from pollination using pollen that had been freshly collected compared to pollen that was frozen and rapidly thawed using the convective thawing apparatus or by directly applying (FIG. 5B).

FIG. 6A and FIG. 6B shows one embodiment of a spouted-bed convective warming apparatus. FIG. 6A shows a photograph of a spouted-bed convective warming apparatus used to thaw cryogenically stored pollen samples between 50-100 mL in volume. FIG. 6B shows a schematic section view of the apparatus comprised of i) an insulated housing that is filled with dry ice, ii) a dual-screw auger feeder and hopper surrounded by dry ice, iii) an external drive and driveshaft used to power the feeder, and iv) a spouted-bed warming chamber through which warm air is passed to rapidly thaw the sample.

FIG. 7 shows a scatter plot illustrating kernel counts obtained from pollinations performed with pollen thawed using either the convective thawing apparatus or by direct application from a vial. The range of kernel counts obtained when using freshly harvested pollen is illustrated by the gray region on the Y-axis. Pictures of the resultant ears are shown directly above the treatment labels, demonstrating excellent seed fill in both treatments.

FIG. 8 shows another embodiment of a spouted-bed convective thawing system incorporating a system to humidify the warming gas.

FIG. 9 is a scatter plot of kernel number per ear from pollinations performed with pollen that was directly applied, thawed for 4 minutes or thawed for 15 minutes, each of which were rehydrated to different extents.

FIG. 10 is a scatter plot of kernel number per ear from pollinations performed with pollen that was sampled 90 minutes, 180 minutes, and 240 minutes after storage.

FIG. 11B and FIG. 11C show one embodiment of a continuous convective thawing system. FIG. 11A shows a photograph of the continuous convective thawing system. FIG. 11B shows a schematic of the thawing system. FIG. 11C shows a section-view of CFD results from a particle simulation showing the path of pollen.

FIG. 12 shows a photograph of ears resulting from the pollination of convectively thawed pollen using the embodiment illustrated in FIG. 11.

FIG. 13 is one embodiment of a conductive warming apparatus.

FIG. 14 shows a photograph of ears resulting from pollination rapidly thawed pollen produced using the conductive thawing system shown in FIG. 13.

FIG. 15 shows one embodiment of a pollen thawer assembly.

FIG. 16 shows one embodiment of a humidification system from the pollen thawer assembly shown in FIG. 15.

FIG. 17 shows one embodiment of a warming chamber from the pollen thawer assembly shown in FIG. 15.

FIG. 18 shows one embodiment of an insulated pollen feeder from the pollen thawer assembly shown in FIG. 15.

### DETAILED DESCRIPTION

Modern plant breeding relies on outcrossing or cross-pollination to generate progeny plants having specific heritable traits. Such breeding strategies play an important role in F1 population development and trait integration. Corn (Zea mays), rice (Oryza sativa), wheat (Triticum aestivum), and sorghum (Sorghum bicolor), which belong to the Poaceae family and the Liliopsida class (monocots) of plants, are examples of economically important agricultural crops in which breeding has been hampered by low efficiency procedures in controlled cross-pollination. Specifically, such cross-pollination procedures require the male donor line and female donor line be planted in the same geographic location and at times such that both lines reach reproductive maturity in synchrony—difficult constraints to achieve in practice. Moreover, conventional methods for cross pollination of such species, for example corn, entails emasculation of female plants and interspersing rows of male parent plants. This process is inefficient as it depends on the effective flow of pollen to the female plants, which is vulnerable to wind. Alternatively, hand pollination may be used, but is highly labor intensive. Furthermore, in plants that exhibit hybrid vigor (heterosis), such as corn, commercial seed sold to farmers is typically F1 hybrid seed, and therefore the same temporal and spatial constraints not only impact the development of new varieties during plant breeding, but also hamper efforts to economically produce seed for sale to farmers. Successful methods to store pollen from such crops for long durations would allow breeders and seed producers to eliminate the spatial and temporal constraints of outcrossing and conduct crosses between parents grown at different times and in different locations, significantly improving workflow efficiency and reliability.

Methods to preserve pollen from corn (Zea mays) and other recalcitrant crops have been previously described (Barnabas and Rajki, Euphytica 25:747-752, 1976; Barnabas and Rajki, Ann. Bot. 48:861-864, 1981; Barnabas, “Freeze preservation of pollen.” Proceeding of the Vth International Symposium on Pollination, 1983; Barnabas, Biotechnol. Agric. For. 25, 607-618, 1994; Buitink et al., Plant Physiol. 111:235-242, 1996). In these methods, the pollen is dried using various methods to a moisture content where desiccation damage is slight, but the cytoplasm may be vitrified using rapid rates of cooling. Pollen from recalcitrant crops has been successfully preserved for up to a decade using the existing methods, however, the existing techniques for recovering samples preserved in this method, such as thawing vials in a warm water bath, fail to provide adequate rates of warming to reliably prevent ice crystallization during thawing resulting in the loss of viability and fertility. Furthermore, such methods are ill-suited for larger scale operation and are incapable of thawing bulk samples. Accordingly, the ability to thaw and condition cryopreserved pollen in a manner that maintains viability and fertility after thawing are needed and are of significant value to the agricultural industry.

The present disclosure provides a significant advancement in the art by providing systems and methods that allow for the rapid thawing and conditioning of cryopreserved pollen, and in some embodiments the rapid thawing of bulk pollen samples, which maintain pollen viability and fertility that has to date not been feasible. The achievement of a reliable means for rapidly thawing cryopreserved pollen after cryogenic storage allows for subsequent use of the pollen in breeding programs or for field seed production, thereby preserving important genetic resources that might otherwise be lost and freeing these programs from the spatial and temporal constraints previously hindering the success of cross-pollination.

In conjunction with the systems and methods described, the current disclosure thus may be used to eliminate the need for synchronized male and female plant development in breeding or hybrid seed production programs while also minimizing the effects of variable weather conditions. The present disclosure therefore permits implementation of high-throughput methods for the delivery of stored donor pollen to a recipient female reproductive part of a plant. The methods provided herein would therefore substantially reduce the time and labor previously required to facilitate cross-pollination in plants. This is of particular significance as modern plant breeding programs may require millions or even tens of millions of individual crosses or more on a yearly basis to produce new plant varieties with improved traits.

The present disclosure provides systems and methods of warming a cryopreserved pollen sample to obtain viable pollen. The method comprises obtaining a cryopreserved pollen sample and rapidly warming the bulk pollen sample, wherein the rapidly thawed bulk pollen sample has increased viability compared to a control pollen sample that is not rapidly thawed. To maintain pollen viability and fertility, pollen should be warmed at a rate that is rapid enough to prevent ice crystal formation and decrease mechanical stress when the sample transitions to or from the glass phase. This minimum rate will vary depending on pollen moisture content, as detailed later. As used herein the term “glass phase” is used to refer to a phase where the intracellular contents of the pollen adopt an amorphous solid structure.

In certain embodiments, a plurality of pollen grains in the cryopreserved pollen sample experiences a warming rate sufficient to prevent ice formation. In other embodiments each grain of pollen in the cryopreserved pollen sample experiences a warming rate sufficient to prevent ice formation. In further embodiments the thawed pollen sample has increased viability compared to a control cryopreserved pollen sample that experiences a warming rate insufficient to prevent ice formation. Minimum warming rates for use in the disclosed methods and systems will vary depending on pollen moisture content. The warming rate experienced at all sub-freezing temperatures should be sufficient to prevent ice formation. The warming rate may be for example at least about 5° C./min, 10° C./min, 20° C./min, 40° C./min, 60° C./min, 80° C./min, 100° C./min, 200° C./min, 300° C./min, 400° C./min, 500° C./min, 600° C./min, 700° C./min, 800° C./min, 900° C./min, 1000° C./min, 1500° C./min, 2000° C./min, 2500° C./min, 3000° C./min, 3500° C./min, 4000° C./min, 4500° C./min, or 5000° C./min, including all ranges derivable therebetween. Any method known in the art which is capable of warming pollen at a rate of at least about 5° C./min or sufficient to prevent ice formation may be used in accordance with the present disclosure. The term “about” is used to indicate that a value includes the standard deviation of the mean for the device or method being employed to determine the value. In some embodiments a variety of heat transfer mechanisms may be employed to achieve these rates of warming including convective, conductive, inductive, and radiative heat transfer techniques or combinations thereof.

One factor that has a significant impact on the viability and fertility of thawed cryopreserved pollen is the moisture content of the cryopreserved pollen sample. The “wet basis moisture content” as used herein refers to the percentage equivalent of the ratio of the weight of water to the total weight of the pollen. The wet basis moisture content of the cryopreserved pollen sample is preferably between about 10% and about 30%. In certain embodiments the moisture content of the cryopreserved pollen sample is between about 15% and about 23%. In other embodiments the moisture content of the cryopreserved pollen sample is between about 17% and about 20%. In further embodiments the moisture content of the cryopreserved pollen sample is preferably at least about 10%, about 11%, about 12%, about 13%, about 14%, about 15%, about 16%, about 17%, about 18%, about 19% or about 20%, or less than about 30%, about 27%, about 25%, about 22%, or about 20%. In another embodiment, the desired moisture content is a wet basis moisture content between about 15% and about 30%. The desired wet basis content measurement may be for example about 10%, 15%, 20%, 25%, or 30%, including all ranges derivable therebetween. In one embodiment, the desired moisture content is a dry basis moisture content. The “dry basis moisture content” as used herein refers to percentage equivalent of the ratio of the weight of water to the dry weight of the pollen. One of skill in the art can readily convert between wet basis moisture content and dry basis moisture content, and these values can be used interchangeably.

The term “about” is used to indicate that a value includes the standard deviation of the mean for the device or method being employed to determine the value. As used herein, “pollen” refers to at least one pollen grain and may comprise a plurality of pollen grains. Non-limiting examples of pollen that may be used according to the systems and methods of the present disclosure include recalcitrant pollen, pollen collected from a dicot plant, a monocot plant, a cereal plant, a Poaceae family plant, an Alismataceae family plant, an Amaranthaceae family plant, a Cactaceae family plant, a Chenopodiaceae family plant, a Cucurbitaceae family plant, a Anacardiaceae family plant, a Portulacaceae family plant, a Urticaceae family plant, a Lauraceae family plant, a Liliaceae family plant, a Iridaceae family plant, a Orchidaceae family plant, a Acanthaceae family plant, a Caryophyllaceae family plant, a corn plant, a rice plant, a wheat plant, a sorghum plant, or a canola plant. As used herein “recalcitrant pollen” refers to desiccation sensitive pollen as described in Pacini and Dolferus (Frontiers in Plant Sci. 10:679; 2019; Barnabas and Rajki, Euphytica 25:747-752, 1976; Barnabas and Rajki, Ann. Bot. 48:861-864, 1981; Barnabas, “Freeze preservation of pollen.” Proceeding of the Vth International Symposium on Pollination, 1983; Barnabas, Biotechnol. Agric. For. 25:607-618, 1994; Buitink et al., Plant Physiol. 111:235-242, 1996). As used herein a “cereal plant” refers to a grass plant cultivated for the edible components of its grain. Non-limiting examples of cereal plants include corn, rice, wheat, and sorghum plants. Pollen for use in the present disclosure includes pollen collected from virtually any plant. In specific embodiments, the pollen may be diploid, haploid, transformed, or pollen collected from a T₀ transformed plant. Pollen for use in the present disclosure may be obtained using any manual or automated methods well-known in the art.

In certain embodiments of the disclosed systems and methods, the pollen sample is a bulk pollen sample. In some embodiments the dry volume of the pollen sample is between about 0.1 mL to 1 mL, 1 mL to 10 mL, 10 mL to 100 mL, 100 mL to 1 L, 1 L to 10 L, 10 L to 100 L, and 100 L to 1,000 L In other embodiments the dry volume of the pollen sample is at least about 0.1 mL, 1 mL, 10 mL, 100 mL, 1 L, 10 L, 100 L, and 1,000 L including all ranges derivable therebetween. In certain embodiments the pollen sample can pollinate a single plant. In other embodiments the pollen sample can pollinate a plurality of plants. In yet other embodiments the bulk pollen sample is of a single genotype. In still other embodiments pollination with the thawed pollen sample results in at least 50% seed set.

In certain embodiments, the cryopreserved pollen may be stored, for example, for up to about 1 year, 5 years, 10 years, 15 years, 20 years, 25 years, or 30 years prior to thawing. The pollen may be stored in other embodiments for at least about 15 minutes, 1 hour, 12 hours, 1 day, 1 week, 1 month, 3 months, 6 months, or 1 year prior to thawing. The pollen may be stored at a temperature between about −196° C. and about −60° C. prior to thawing. The storage temperature may be, for example, about −196° C., −190° C., −180° C., −170° C., −160° C., −150° C., −140° C., −130° C., −120° C., −110° C., −100° C., −90° C., −80° C., −75° C., −70° C., −65° C., or −60° C. In one embodiment, the storage temperature is less than about −60° C.

In certain embodiments, the system comprises a chamber containing the cryopreserved pollen sample in which a warmed gas is introduced to convectively warm the cryopreserved pollen sample and achieve an appropriate warming rate as described herein. In further embodiments the gas is air, nitrogen, oxygen, helium, argon, or a combination thereof. In still further embodiments, the air or gas may be adjusted to a desired humidity level to control the moisture content of the sample during the warming process to prevent continued dehydration or promote rehydration. The relative humidity of the air or gases used for warming pollen in the disclosed systems and methods may range from 10% to 100% relative humidity. In preferred embodiments, the relative humidity ranges from 80% to 100%. In other embodiments, the relative humidity may be at least about 10%, 20%, 30%, 40%, 50%, 60%, 70%, 80%, 90%, and 100% including all ranges derivable therebetween. A variety of methods known in the art may be employed to humidify the gas, including but not limited to two-pressure humidity generation, steam injection, bubbler systems, humidifier pads, and controlled mixing and evaporation using mass flow controllers.

It is well known in the art that the surfaces of pollen exhibit delicate structures and a surface coating that are critical to initial interactions with the stigma that are necessary for proper germination on the stigma. Mechanical handling of pollen may damage these features and impair the pollen's ability to germinate on the stigma. To minimize such mechanical damage, some embodiments limit the motion subjected to the cryopreserved pollen sample. In several such embodiments, the system comprises a second chamber in fluid communication with the first chamber. In such systems, the cryopreserved pollen sample is pneumatically conveyed by the warm gas through the first chamber to the second chamber wherein the gas velocity is low permitting the pollen to gently settle out of the gas stream.

Additional systems to rapidly thaw pollen are described herein. In some embodiments, the system comprises a chamber containing a warm liquid into which the cryopreserved sample is dispensed to conductively warm the pollen and obtain appropriate rates of warming as described herein. In alternative embodiments, warm liquid is dispensed into the cryopreserved pollen sample. The liquid may be water, an aqueous solution, an organic solvent, a conventional emulsion, or a reverse emulsion. In preferred embodiments the temperature of the liquid is between about 4° C. and 40° C.

In another embodiment, the system comprises a warm surface to which the cryopreserved pollen sample is introduced. The cryopreserved sample is warmed through conduction attaining the warming rates needed to avoid ice crystal formation as described herein. In preferred embodiments, the surface is actively heated and maintained at a controlled temperature between about 4° C. and 40° C. In other embodiments, the surface temperature is controlled to between 4° C. and 100° C. including all ranges derivable therebetween. In further embodiments, the surface conveys the cryopreserved pollen permitting the continuous thawing of a bulk cryopreserved pollen sample.

In still another embodiment, the system comprises a chamber with an inductive heating apparatus into which a cryopreserved pollen sample mixed with a ferromagnetic powder is placed. The inductive heating apparatus warms the ferromagnetic particles, which in turn warm the adjacent pollen through conduction and convection attaining the rates of warming necessary to avoid ice crystal formation as described herein.

In yet another embodiment, the system comprises a chamber wherein the cryopreserved pollen is introduced and exposed to electromagnetic radiation that radiatively warms the pollen at sufficient rates to avoid ice crystallization as described herein. The electromagnetic radiation may fall under the microwave or infrared wavelengths.

In some systems disclosed, the maximum rate of warming that can be achieved is dependent upon the amount of cryopreserved pollen sample being handled. To ensure the systems heating capacity is not overwhelmed, additional embodiments comprise a cooled container in which the cryopreserved pollen sample is maintained below the glass transition temperature until the moment the sample is dispensed into downstream warming conditions. In further embodiments, the cooled container comprises a feeding mechanism to meter the cryopreserved pollen sample into the warming conditions. Feeding mechanisms include, but are not limited to screw augers, table feeders, rotary feeders, belt feeders, and positive displacement feeders.

Following thawing using the systems and methods of the present disclosure, pollen can maintain fertility for durations of several hours to several days depending upon the storage conditions. The fertility of the pollen may be maintained for durations for example of at least about 30 minutes, 1 hour, 2 hours, 4 hours, 8 hours, 12 hours, 24 hours, 48 hours, 72 hours, or 96 hours including all ranges derivable therebetween. The storage temperature of pollen following thawing using the systems and methods of the present disclosure may be for example at least about 0° C., 4° C., 20° C., 30° C., or 50° C. including all ranges derivable therebetween. The relative humidity conditions during storage of pollen following thawing using the systems and methods of the present disclosure may be for example at least about 60%, 70%, 80%, 90%, or 100% including all ranges derivable therebetween.

Following drying, the membranes of pollen have become dehydrated, which leads to reduced adherence on the stigma and requires a longer period for germination to proceed (Barnabas and Fridvalszky, Acta Bot. Hung. 30:329-332, 1984). Rehydrating the pollen during or following thawing using the systems and methods described in the present disclosure can improve adhesion to the stigma and reduce the time required for germination to proceed thereby improving pollination efficacy. In certain embodiments, rehydration may be accomplished through vapor sorption wherein pollen is exposed to an atmosphere of sufficient humidity and for sufficient time to drive rehydration. The temperature of such atmospheres may range from at least about 0° C., 4° C., 20° C., 30° C., or 50° C. including all ranges derivable therebetween. The relative humidity of the atmosphere may be for example at least about 60%, 70%, 80%, 90%, or 100% including all ranges derivable therebetween. The duration of exposure may be for example at least about 1 minute, 10 minutes, 30 minutes, 1 hour, 24 hours, 48 hours, or 96 hours including all ranges derivable therebetween. In other embodiments rehydration may be accomplished through direct contact with aqueous solutions or emulsions of water in organic solvents and oils.

The systems and methods of the present disclosure surprisingly permits cross-pollination of potentially any flowering plant or grass using cryopreserved pollen samples that have been rapidly thawed. In one embodiment, a method for pollinating a plant comprises: (a) obtaining a rapidly thawed pollen or bulk pollen sample from a cryopreserved pollen or bulk pollen sample; and (b) pollinating the plant with the pollen. In certain embodiments, the pollinating results in at least 50% seed set. In some embodiments, the methods of the disclosure may be optimized for a particular application, particular plant species, or particular pollen type. Non-limiting examples of plants that may be used according to the methods of the present disclosure include plants with recalcitrant pollen, dicot plants, monocot plants, cereal plants, Poaceae family plants, Alismataceae family plants, Amaranthaceae family plants, Cactaceae family plants, Chenopodiaceae family plants, Cucurbitaceae family plants, Anacardiaceae family plants, Portulacaceae family plants, Urticaceae family plants, Lauraceae family plants, Liliaceae family plants, Iridaceae family plants, Orchidaceae family plants, Acanthaceae family plants, Caryophyllaceae family plants, corn plants, rice plants, wheat plants, sorghum plants, and canola plants. In some embodiments, the pollinating comprises manually applying or spraying the pollen onto a female reproductive part of the plant. Non-limiting examples of manual application include applying pollen with a cotton swab or small brush to the female reproductive part of a recipient plant and using a measuring spoon to transfer pollen from a container, such as a bag or graduated tube, to the female reproductive part of a recipient plant. Spraying may include but is not limited to air-assisted spraying or spraying using a common agricultural nozzle.

In particular embodiments, pollinations using pollen thawed according to the methods and systems described herein produce at least about 1 seed, 5 seeds, 10 seeds, 15 seeds, 20 seeds, 25 seeds, 30 seeds, 35 seeds, 40 seeds, 45 seeds, 50 seeds, 55 seeds, 60 seeds, 65 seeds, 70 seeds, 75 seeds, 80 seeds, 85 seeds, 90 seeds, 95 seeds, or 100 seeds per 5 mg of rapidly thawed pollen used for pollinating. In one embodiment, the pollinating produces a substantially increased number of seeds compared to the number of seeds produced from pollination under the same conditions but using pollen that was not rapidly thawed. A substantial increase is evaluated by comparing seed sets produced using cryopreserved pollen or bulk pollen that is rapidly thawed according to the systems and methods provided herein to seed sets produced using cryopreserved pollen or bulk pollen that was not rapidly thawed.

In another aspect, a method for evaluating pollen viability is to determine the percentage of seed set, as detailed in the examples disclosed. Another method of evaluating pollen viability comprises: (a) obtaining thawed pollen or bulk pollen sample; (b) delivering the thawed pollen to a female reproductive part of a recipient plant; (c) washing the female reproductive part of the recipient plant to remove non-adhered pollen; and (d) evaluating adherence of the pollen to the female reproductive part of the recipient plant. In one embodiment, the evaluating is quantitative. In another embodiment, the evaluating comprises counting the number of pollen grains adhered to the female reproductive part of the recipient plant. In still yet another embodiment, the adhered pollen is fixed to the female reproductive part of the recipient plant prior to step (d). Pollen from virtually any plant may be evaluated using the methods described herein.

The step of collecting seed resulting from pollinating with cryopreserved pollen or bulk pollen rapidly thawed according to the systems and methods of the present disclosure is provided herein. In a particular embodiment, a progeny plant produced from the collected seed may be crossed with itself or a different plant. In certain embodiments, a method of producing hybrid seed is provided herein comprising producing rapidly thawed pollen or bulk pollen using the systems and methods described herein, delivering the thawed pollen to a female reproductive part of a recipient plant, thereby pollinating the female reproductive part with the pollen from the donor plant, harvesting seed produced from the pollination; and identifying hybrid progeny. Selecting a progeny seed or plant that results from pollinating with rapidly thawed pollen or bulk pollen may also performed. Identifying and selecting progeny could be facilitated by use of a polymorphic marker allele contained in the pollen donor that serves to identify progeny plants or seeds of that donor. Morphological markers or biochemical/protein markers have commonly been used as tools for selection of plants with desired traits in breeding. Molecular marker techniques that have been extensively used and are particularly promising for application to plant breeding include: restriction fragment length polymorphisms (RFLPs), amplified fragment length polymorphisms (AFLPs), random amplified polymorphic DNA (RAPD), microsatellites or simple sequence repeats (SSRs), and single nucleotide polymorphisms (SNPs) (Al-Khayri, et al., Advances in Plant Breeding Strategies, 2016).

In yet another embodiment, the method further comprises repeating the steps of (a) obtaining rapidly thawed pollen according the methods and systems provided herein; and (b) pollinating the plant with the thawed pollen, on two or more consecutive days. These steps may be repeated, for example, on two consecutive days, three consecutive days, four consecutive days, or on five or more consecutive days. In corn, for example, it can be found that repeating the delivering steps on two or three consecutive days can result in higher seed set.

In still other embodiments, the methods described herein may comprise pollination of flowers that are male sterile at the time of pollinating. Depending upon the developmental stage of the plant, donor rapidly thawed pollen applied for cross-pollination could compete with pollen produced by the recipient plant. In order to improve the efficacy of the cross-pollination, it may be advantageous in some cases that the recipient plant be male sterile in an effort to reduce competition with selfing. Thus, a male sterility system could be employed with the female parent plant in a particular cross. Many such male sterility systems are well known, including cytoplasmic male sterility (CMS) and genic male sterility (GMS). CMS and GMS facilitate hybrid seed production for many crops and thus allow breeders to harness yield gains associated with hybrid vigor. The use of a gametocide presents an alternative method to produce male sterility. Gametocides affect processes or cells involved in the development, maturation or release of pollen. Plants treated with such gametocides are rendered male sterile, but typically remain female fertile. The use of chemical gametocides is described, for example, in U.S. Pat. No. 4,936,904, the disclosure of which is specifically incorporated herein by reference in its entirety. Furthermore, the use of Roundup® herbicide in combination with glyphosate tolerant corn plants to produce male sterile corn plants is disclosed in PCT Publication WO 98/44140. Several gametocides have been reported effective in inducing pollen sterility in various crops and are well known in the art. Such gametocides include sodium methyl arsenate, 2,3-dichloroisobutyrate, sodium 2,2-dichloropropionate, gibberellic acid, maleic hydrazide (1,2-dihydropyridazine, 3-6-dione), 2,4-dichloro phenoxy acetic acid, ethyl 4-fluorooxanilate, trihalogenated methylsulfonamides, ethyl and methyl arsenates (Ali et al., Genetics Plant Breeding, 59:429-436, 1999). Physical emasculation of the recipient plant presents another alternative to produce male sterility. Following emasculation, the plants are then typically allowed to continue to grow and natural cross-pollination occurs as a result of the action of wind, which is normal in the pollination of grasses, including corn. As a result of the emasculation of the female parent plant, all the pollen from the male parent plant is available for pollination because the male reproductive portion, and thereby pollen bearing parts, have been previously removed from all plants of the plant being used as the female in the hybridization. Of course, during this hybridization procedure, the parental varieties are grown such that they are isolated from other plants to minimize or prevent any accidental contamination of pollen from foreign sources. These isolation techniques are well within the ability of those skilled in this art.

The methods disclosed herein may be implemented for improved cross-pollination of potentially any plants. Such plants can include, but are not limited to, cereal plants, non-limiting examples of which are corn, wheat, rice, and sorghum.

The embodiments of the disclosure described herein are not intended to be exhaustive or to limit the disclosure to the precise forms disclosed. Instead, the embodiments selected for description have been chosen to enable one skilled in the art to practice the invention. It should be understood that the concepts presented herein may be used in various applications and should not be limited to use in the specific embodiments depicted in the examples below or the drawings.

### EXAMPLES

### Example 1. Identifying Critical Rates of Warming Using Differential Scanning Calorimetry

During cryopreservation, the pollen cytoplasm is vitrified to reach an amorphous, glass-like state during freezing, which minimizes ice crystal formation and its associated mechanical stress. Vitrification has been extensively studied and has been exploited as a common technique to preserve biological specimens in the field of cryopreservation. Vitrification entails rapidly cooling a sample such that the viscosity of the cytoplasm increases at a rate much greater than ice crystallization proceeds. Upon continued cooling below a certain temperature, commonly referred to as the “glass transition temperature,” the viscosity of the cytoplasm becomes so great that molecular mobility is hindered and the sample behaves as an amorphous solid. When stored in this glassy state, ice crystallization does not occur over meaningful time scales. Rapid rates of warming must be employed to recover vitrified samples to ensure damaging ice crystallization does not occur upon warming. The critical rates of warming required to recover vitrified samples are typically several fold higher than the needed cooling rates. Therefore, to preserve maximum pollen viability during the thawing stage, pollen must be warmed at a rate that prevents ice crystal formation and mechanical stress. The necessary warming rate is dependent on the moisture content of the pollen, and may vary for each pollen intracellular component. It may be necessary to warm pollen as rapidly as possible as the temperature approaches and traverses the glass transition temperature and at temperatures above the glass transition temperature, however, it may be necessary to warm pollen at a slower rate when the temperature of the pollen is substantially below the glass transition temperature.

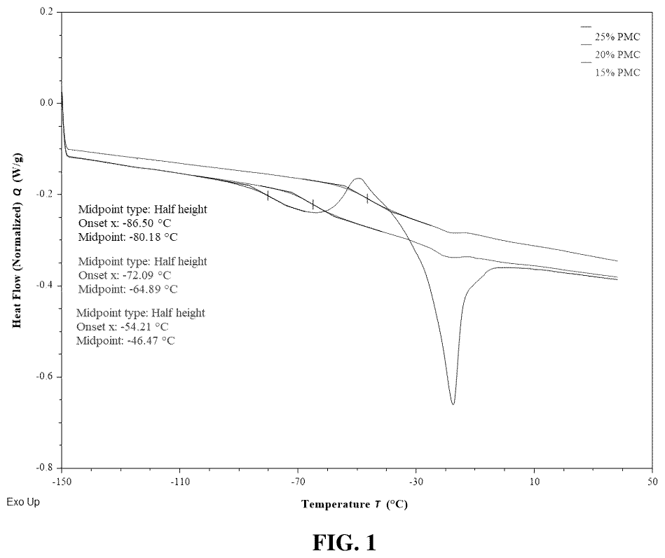

Differential scanning calorimetry may be used to identify the critical warming rates needed to successfully recover a vitrified sample of pollen by exposing the sample to increasing rates of warming until exothermic crystallization events are no longer evident in the resulting thermograms. In one such experiment, corn pollen was collected and divided into three fluid bed dryers and dried to 25.8%, 21.1%, and 15.1% wet-basis moisture content. Following drying, approximately 10-15 mg of pollen from each of the dried samples was loaded into a hermetically sealed aluminum sample pan (TA Instruments Cat. #901683.901) and placed in the autosampler of a TA Instruments DSC2500 differential scanning calorimeter equipped with a liquid nitrogen cooling pump. Each pollen sample was quench-cooled to −150° C. in the sample chamber of the instrument and subjected to a constant warming rate of 10° C./min. The resulting plots of mass-normalized heat flow versus temperature for each sample are shown in FIG. 1.

As can be seen in the thermograms in FIG. 1, samples dried to wet basis moisture contents of 15.1% and 21.1% (labelled as 15% PMC and 20% PMC in the legend) do not exhibit prominent exothermic peaks. The absence of exothermic peaks in these samples indicates that the 10° C./min rate of warming was sufficient to prevent measurable ice crystallization upon warming. In contrast, the thermogram from the sample dried to a wet-basis moisture content of 25.8% (labelled at 25% PMC in the legend) exhibits a prominent exothermic peak at approximately −55° C., indicating that the 10° C./min rate of warming was insufficient to prevent measurable ice formation in this higher-moisture content sample. The results from this experiment highlight the need to employ warming rates greater than about 5° C./min, and preferably greater than about 10° C./min, to recover cryopreserved pollen and maintain adequate viability and fertility.

### Example 2. Comparison of Water Bath Thawing to Rapid Thawing Technique

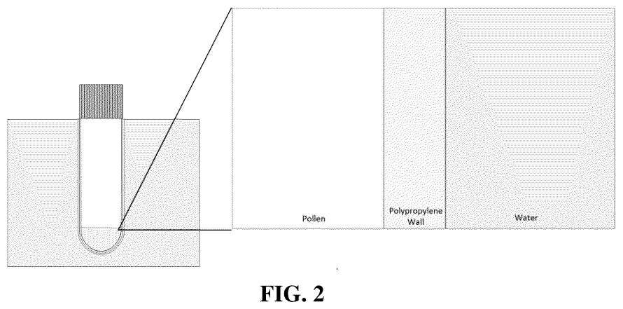

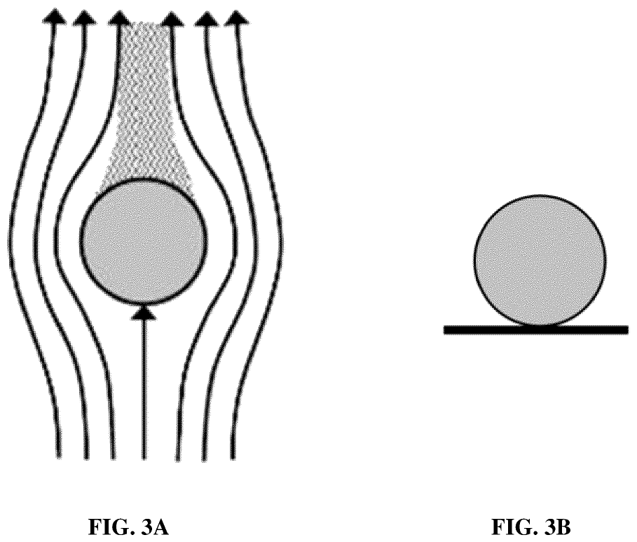

Due to complex relationship between warming rate and pollen moisture content and the need for rapid rates of warming exceeding 10° C./min, existing methods described in the prior art for thawing recalcitrant or monocot pollen do not provide reproducible results. In one such technique described by Barnabas (Barnabas and Rajki, Euphytica 25:747-752, 1976), freshly shed maize pollen is dried in a fluid bed dryer to a wet basis moisture content of 15-20%, transferred into a polyethylene vial, rapidly frozen by immersion in liquid nitrogen or dry ice, and stored for indefinite periods at temperatures of −196° C. or −76° C. After withdrawing the samples from storage, the frozen samples are thawed by submerging the vials in a warm water bath. When the cold vial containing pollen is submerged in a warm water bath in this method, the wall of the vial and the pollen itself insulate the sample limiting the rate of warming (FIG. 2). In contrast, directly applying pollen from the vial to the stigma immediately upon withdrawal from cryogenic storage exposes individual pollen grains to large temperature gradients either in the atmosphere or in contact with the stigma surface (FIG. 3A and FIG. 3B, respectively). Without the resistance of the vial wall or adjacent pollen grains, these large temperature gradients warm the grains at much higher rates compatible with cryopreserved samples having higher moisture contents.

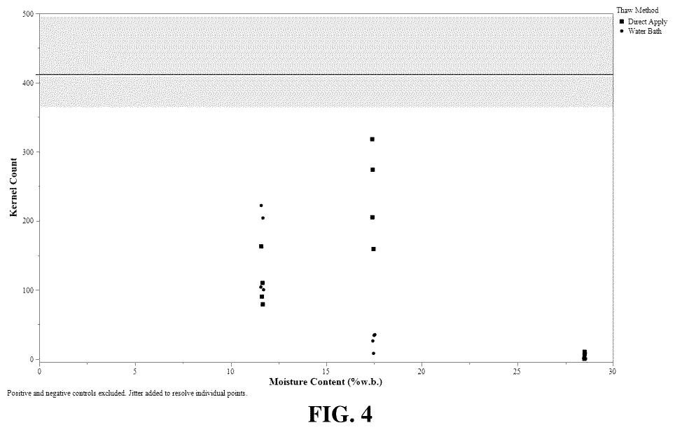

To illustrate these effects an experiment was performed in which freshly collected maize pollen was dried in three separate fluid bed dryers to wet-basis moisture contents of 11.7%, 17.5%, and 28.5%. After drying, the samples were loaded into 2.0 mL polypropylene vials in 0.15 mL aliquots. The vials were then sealed, rapidly frozen by immersion into liquid nitrogen, and stored at −196° C. in a CryoPod (Brooks Life Science) for approximately 3 hours until pollinations could be performed. Half of the stored vials from each moisture content sample were thawed by immersion in a water bath at 37° C. for 2 minutes while the remaining half of the vials were directly applied to the recipient plants immediately upon withdrawal from cryogenic storage (hereafter termed “direct apply”). A scatter plot of the resulting kernel number per ear for each of the experimental treatments is provided in Error! Reference source not found.FIG. 4. As can be seen in the plot, both thawing methods yield similar kernel numbers per ear with the sample having a moisture content of 11.7%. In contrast, a substantial improvement in kernel number per ear was observed with the direct apply technique with the sample having a wet basis moisture content of 17.5%. The differences in seed set between the thawing techniques may be attributed to differences in warming rate—in the higher moisture content sample, only the direct apply technique exposes pollen to a warming rate sufficient to prevent ice crystallization. These findings illustrate the limitations of thawing methods described in the prior art and highlight the importance, and potential benefits, of employing rapid warming rates to thaw cryopreserved pollen.

### Example 3: Efficacy of Convective Thawing Techniques

In certain applications such as commercial seed production, it is desirable to cryopreserve and recover pollen in bulk quantities larger than can be contained within a single vial. In these applications, systems and methods capable of rapidly warming every pollen grain within a bulk sample of cryopreserved pollen are needed. One such technique entails feeding a pollen sample into a warm airstream immediately upon removal from cryogenic storage conditions. Such techniques rely upon convective heat transfer to warm the grains. Feeding pollen into the warm air stream exposes the entirety of each grain's surface area to large temperature gradients as illustrated in FIG. 3A thereby attaining very rapid warming rates.

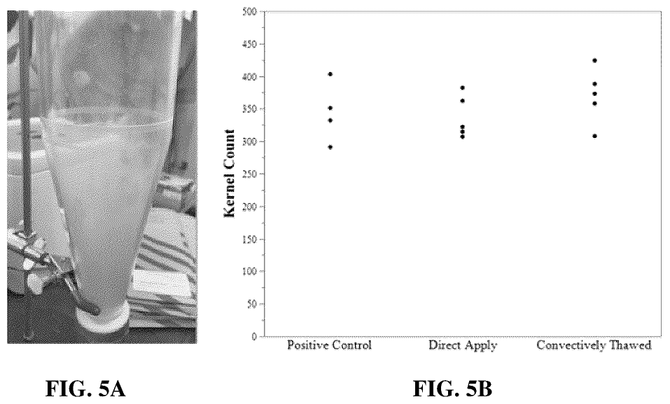

An initial experiment was performed to assess the efficacy of convective thawing techniques in which approximately 14 g of freshly collected corn pollen was dried in a fluid bed dryer to a wet basis moisture content of 17.8%. After drying, the pollen was distributed into 2 mL polypropylene cryovials in 0.15 mL aliquots. The vials were sealed, rapidly frozen by immersion into liquid nitrogen, and stored at −140° C. in a CryoPlus liquid nitrogen vapor freezer (Thermo Fisher Scientific) for 18 hours until pollinations could be performed. The following day, four pollinations were performed using 0.15 mL of freshly collected pollen to serve as a positive control. A subset of the frozen vials were directly applied to the plants upon removal from cryogenic storage. The contents of the remaining vials were thawed by withdrawing a vial from cryogenic storage and dispensing the pollen into a convective thawing apparatus illustrated in FIG. 5A. Briefly, the apparatus was comprised of a chamber having a lower conical section joined to an upper cylindrical section. Warm air was introduced vertically into the chamber at the bottom of the tapered section through a porous distribution plate. An air compressor located in the greenhouse provided air for the system, which was metered into the chamber using a mass flow controller (Alicat Scientific, MC100SLPM). In the lower tapered section of the chamber, the air velocity is high but gradually decreases as the cross-sectional area of the chamber increases. As such, when frozen pollen is introduced at the top, it falls through the low velocity warm air until the velocity of the air is sufficient to entrain the grain. The grains are lofted until the air velocity is insufficient to lift the particles. The pollen continues to circulate in this “spouting bed” until airflow is ceased.

Kernel number per ear results from the pollinations are illustrated in the scatterplot shown in FIG. 5B. As can be seen from the plot, all thawed pollen treatments yielded kernel counts indistinguishable from those obtained with fresh pollen illustrating the efficacy of the convective thawing technique in processing quantities of pollen greater than can be contained in a single vial. Importantly, the technique may be scaled to work with any volume of pollen ranging from fractions of a milliliter to tens or hundreds of liters.

### Example 4: Construction of an Automated Convective Thawing System

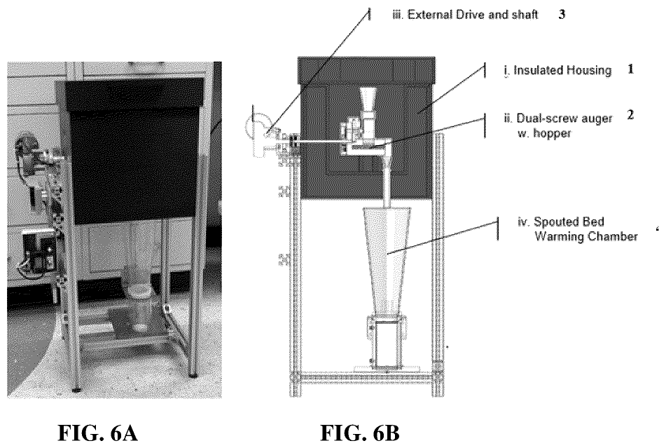

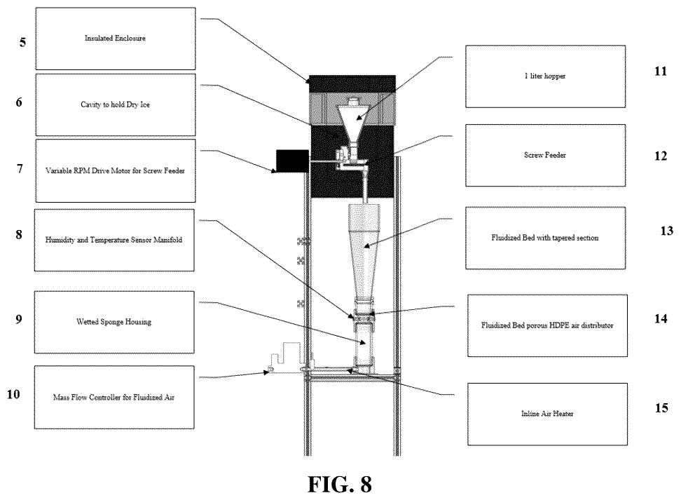

When working with larger volumes of pollen than several milliliters it is desirable to automate a thawing system to increase throughput, reliability, ease of use, and reproducibility. In one experiment, modifications were made to the spouted-bed system shown in FIG. 5A to automate the convective thawing process. The resulting convective thawing apparatus is illustrated in FIG. 6A and FIG. 6B. Briefly, the system shown in FIG. 6A and FIG. 6B is comprised of an insulated housing 1 in which a hopper and dual-screw feeder 2 assembly is mounted. A drive motor 3 is used to turn the screw feeder. The entire housing is filled with dry ice to cool the hopper and auger feeder to −76° C., which is below the glass transition temperature of the cryopreserved pollen sample. After cooling the housing, frozen pollen is directly transferred to the hopper and is slowly metered into a spouted bed warming chamber 4 below. Warm air is passed upwards through the chamber. Near the base of the chamber, the cross-sectional area is small and air velocity high. As the cross-sectional area increases in the conical section, the air velocity drops. This chamber is a spouted bed warming chamber 4. This “spouting bed” flow pattern ensures pollen is continuously entrained in air but contained within the chamber. This system ensures that pollen grains are maintained at ultra low temperatures until the moment they are exposed to large temperature gradients in the spouted bed. Furthermore, the addition of a metering system ensure pollen is fed into the chamber at an appropriate rate such that the pollen experiences a rapid rate of warming. In addition to the noted components, the convective thawing apparatus of FIG. 6B includes components which are not specifically shown in the drawing, but that can be found in FIG. 8, including a cavity to hold dry ice 6, a humidity and temperature sensor manifold 8 which contains humidity and temperature sensors, a mass flow controller 10 for the air input into the system, a hopper 11 in which pollen is placed, a porous HDPE air distributor 14 at the bottom of the spouted bed warming chamber.

To test the system illustrated in FIG. 6A and FIG. 6B, a study was conducted in which approximately 100 mL of corn pollen was dried to a wet-basis moisture content of 18.21% using a fluid bed dryer. Following drying, the pollen was rapidly frozen by direct immersion in liquid nitrogen and stored at −140° C. until later use. After 77 days of storage the pollen was removed from storage and rapidly transferred to the hopper of the convective thawing system. The pollen was slowly metered over the course of 2 minutes from cryogenic conditions in the hopper into the chamber. After thawing for an additional 2 minutes at a temperature of 28° C. and relative humidity of 60%, the airflow is turned-off and the pollen is withdrawn from the spouted bed warming chamber 4. The pollen settles to the bottom of the spouted bed warming chamber, sitting on a porous HDPE air distributor 14. The warm pollen was removed from the thawing system and applied by hand to recipient plants. Several small samples of the same pollen batch were frozen in cryovials and directly applied to the plants to allow performance comparisons between the thawing techniques. Pollinations were also performed with freshly collected pollen to assess the maximum seed set potential of the female plants.

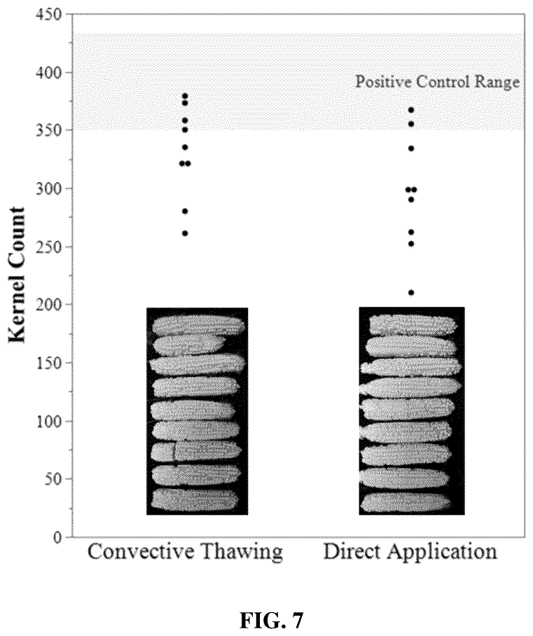

Results from the study are summarized in FIG. 7, which shows that the seed set results for both the convectively thawed samples and the directly applied samples overlap. Further analysis reveals no statistically significant differences between the mean seed sets of both treatment groups. Furthermore, both treatments yielded mean kernel counts roughly 80-85% of the positive control samples, with some data points within the range of positive controls. These findings demonstrate that the convective thawing techniques can be employed to rapidly thaw large volumes of pollen while maintaining the fertility and viability of the sample.

### Example 5: Humidification of Warming Air to Prevent Desiccation and Effect Rehydration

Procedures for cryopreserving recalcitrant pollen in the prior art entail “drying grains . . . to a moisture content where desiccation damage is slight and then lower the temperature to −76 or −96° C. (Buitink et al., Plant Physiol. 111:235-242, 1996). Given that pollen from recalcitrant species such as corn are particularly susceptible to desiccation, additional desiccation experienced during thawing and post-thaw handling steps may inadvertently damage the pollen. Consequently, thawing methods should take care to prevent further desiccation while recovering cryopreserved pollen. The convective thawing system in FIG. 6A and FIG. 6B was modified to humidify the air to a level where desiccation of pollen during thawing is prevented, or alternatively, to a level where grains are rehydrated during the thawing process. The modified assembly, illustrated in FIG. 8, is comprised of the same components as the assembly illustrated in FIG. 6A and FIG. 6B with the addition of an inline heater 15 and housing for wet sponges 9. During operation, the airflow metered into the system using a mass flow controller 10 is heated by the inline heater and passed through the sponges saturated in water. As water evaporates, it cools and humidifies the airflow. The temperature of the air entering the wet sponges may be adjusted to achieve many humidity and temperature combinations in the warming chamber.

### Example 6: Rehydration of Pollen During Thawing Improves Pollination Performance

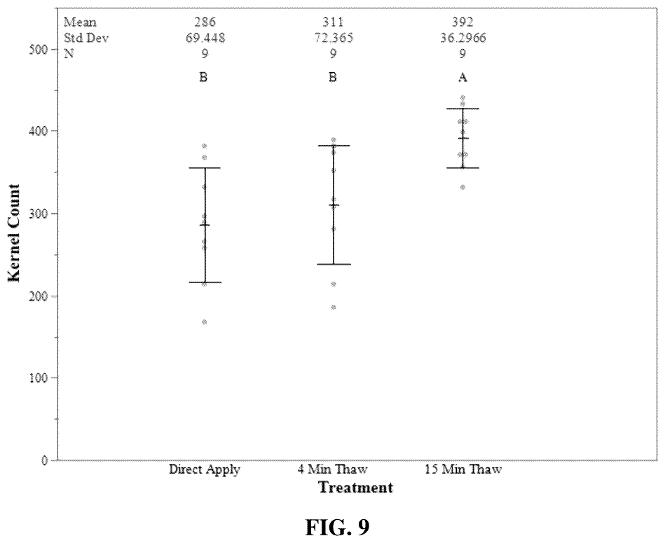

Pollen from recalcitrant species can only be stored successfully if it has first been dried to an adequate extent, however, pollen dried in this manner has reduced adhesion on the stigma and requires longer periods to germinate (Barnabas and Fridvalszky, Acta Bot. Hung. 30:329-332, 1984). Rehydrating the pollen during or following thawing can restore the properties of membranes and improve adhesion on the stigma and reduce the time required to germinate. To demonstrate the benefits of rehydrating the pollen during or after the thawing step, a study was conducted wherein approximately 100 mL of freshly collected corn pollen was dried in a fluid bed dryer to a wet basis moisture content of 20.81%. After drying, approximately 2 mL of the dried pollen was divided into 2 mL polypropylene cryovials in 0.15 mL aliquots. The vials were then sealed, and rapidly frozen by immersion into liquid nitrogen. The remaining pollen, approximately 50 mL in volume, was frozen by directly immersing into liquid nitrogen in a 50 mL conical tube. The conical tube containing pollen-liquid nitrogen slurry was covered with a vented cap to vent nitrogen as the liquid nitrogen continued to evaporate in storage. Both the individual vials and the sample frozen in bulk were transferred to and stored in a mechanical freezer at −150° C. (PHCbi MDF-C2156VANC-PA) for 50 days. After storage, the vials were removed from storage and directly applied to recipient plants in a field setting. The bulk sample was withdrawn from storage and transferred to the insulated hopper of the system shown in FIG. 8. Approximately half of the sample was slowly fed into the warming chamber operating at 25° C. and 95% relative humidity. The pollen was allowed to remain in the warm, humid air for 4 minutes after which it was removed from the system, sampled for moisture content, and applied to recipient plants within 30 minutes of thawing. The remaining half of pollen was similarly thawed, but allowed to remain in the warm, humid air for 15 minutes after which it was removed from the system, sampled for moisture content, and applied to recipient plants within 30 minutes of thawing. After the varying durations of incubation, the directly applied samples, samples incubated for 4 minutes, and samples incubated for 15 minutes had wet-basis moisture contents of 20.81%, 26.9%, and 30.73%, respectively. The differences in moisture content illustrate the ability of the system to rehydrate the pollen samples during thawing and incubation. The resulting kernel counts per ear resulting from the pollinations are shown in the scatter plot illustrated in FIG. 9. Pollinations from samples that were directly applied from vials and from the sample that had been incubated for 4 minutes during the thawing process yielded statistically equivalent mean kernel counts of roughly 300 kernels per ear. In comparison, pollinations made with pollen that had been incubated 15 minutes during the thawing process yielded a statistically higher mean kernel count per ear of 392 kernels per ear with a substantially reduced standard deviation. The improvement in seed set and reduction in ear-to-ear variability observed with the highest moisture content sample highlights the benefits of rehydrating pollen during or after the thawing process.

### Example 7: Pollen Longevity After Thawing

When cryopreserved pollen is rapidly thawed using the systems and methods described within this application, the thawed pollen may be stored several hours to several days and maintain fertility—a desirable capability for practical breeding and seed production workflows.

To demonstrate the longevity of pollen after thawing, a study was conducted in which freshly collected corn pollen was dried in a fluidized bed dryer to a wet-basis moisture content of 21.1%, frozen by directly immersing in liquid nitrogen, and stored at −150° C. for 49 days. Following storage, the pollen was rapidly thawed using the system illustrated in FIG. 8. Immediately after thawing, several pollinations were performed. The remaining pollen was placed in a sealed glass jar at 4° C. The stored pollen was intermittently sampled 90 minutes, 180 minutes, and 240 minutes after storage and pollinations were performed with the pollen at these time points. Additionally, pollinations were performed with additives containing an inert silica powder with diameter similar to that of corn pollen, to serve as a negative control and with pollen directly applied from cryogenically stored vials.

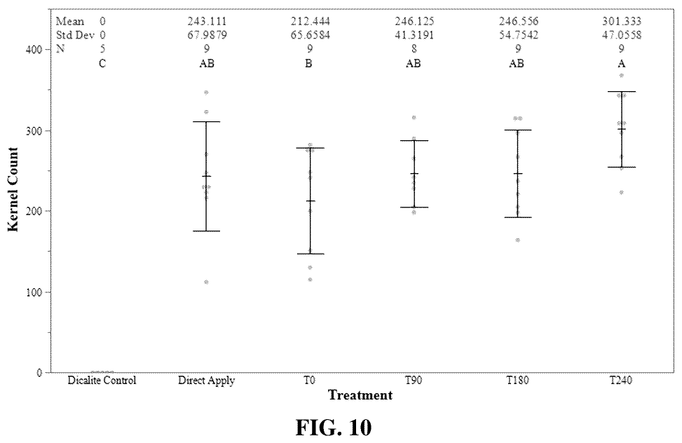

Results from the pollination experiments are illustrated in FIG. 10. Statistical analysis with a Tukey Post-Hoc Honest Significant Difference test reveals no statistically significant differences in mean kernel count between the pollinations performed immediately after thawing up to 240 minutes after thawing. The findings illustrate that pollen thawed using the systems and methods described in the present disclosure maintains fertility for several hours after thawing, allowing time and flexibility between thawing and pollination processes.

### Example 8: Continuous Operation Convective Thawing System

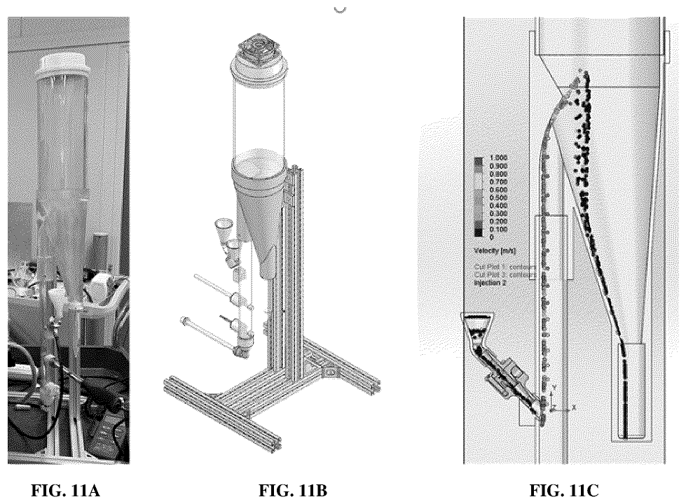

In another study, the system illustrated in FIG. 11 was constructed and tested. Briefly, the system is comprised of a vertically oriented tube through which warm humidified air is passed upwards. Cryopreserved pollen is introduced into the rising air flow through the side wall of the tube. As the pollen is introduced, it is immediately exposed to large temperature gradients and is entrained in the upwards air flow. As the pollen is conveyed, it continues to rapidly warm until it reaches a settling chamber where the air velocity is low enough for the pollen to separate from the bulk air flow. The process can operate continuously.

To test the system, approximately 25 mL of pollen was dried to a moisture content of 19.01% (wet basis) using a fluidized bed dryer. The pollen was subsequently frozen by immersion in liquid nitrogen. The frozen pollen was then slowly fed into the convective thawing system over the course of 2 minutes while operating with an airstream at 28° C. and 80% relative humidity (RH). The thawed pollen was collected from the settling chamber and hand-applied to female plants in a greenhouse.

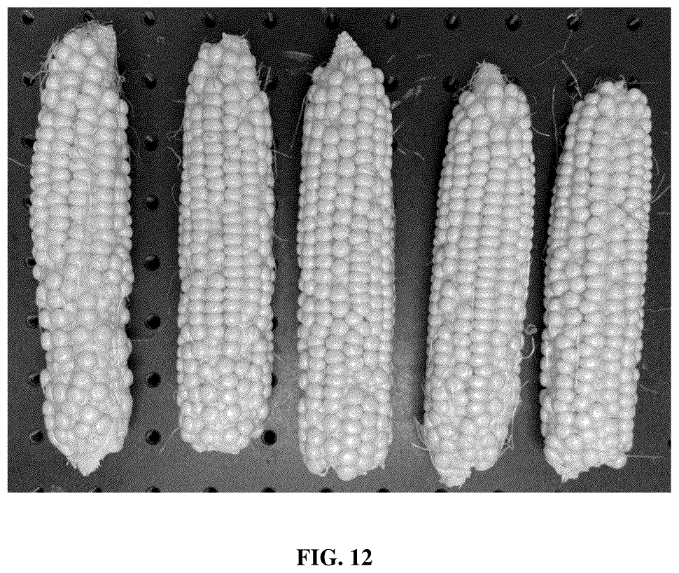

Resulting ears from the pollinations are shown in FIG. 12. As can be seen from the image, all ears pollinated with the convectively thawed pollen demonstrate excellent seed fill, again demonstrating the ability to maintain pollen fertility and viability at larger scales through the use of convective thawing methods.

### Example 9: Systems Employing Conductive Heat Transfer to Thaw Cryopreserved Pollen

The systems in the previously described examples have all relied upon convection to rapidly warm cryopreserved pollen samples, however, additional systems may instead rely upon conduction to rapidly warm thin layers of pollen. Such systems may be comprised of: 1) Optionally an insulated or actively cooled container or hopper that maintains the preserved sample below the glass transition temperature until the moment of warming; 2) optionally a conveyance system capable of dispensing the frozen pollen onto a warmed surface, which may include, but is not limited to, screw augers, vibratory feeders, table feeders, rotary feeders, and plungers; and 3) a warm surface onto which pollen is deposited in a thin layer to provide intimate contact with the warm surface and a rapid rate of warming. Studies using such systems have demonstrated success.

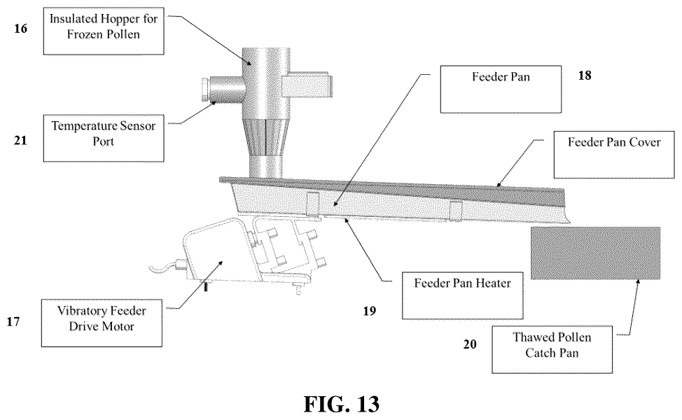

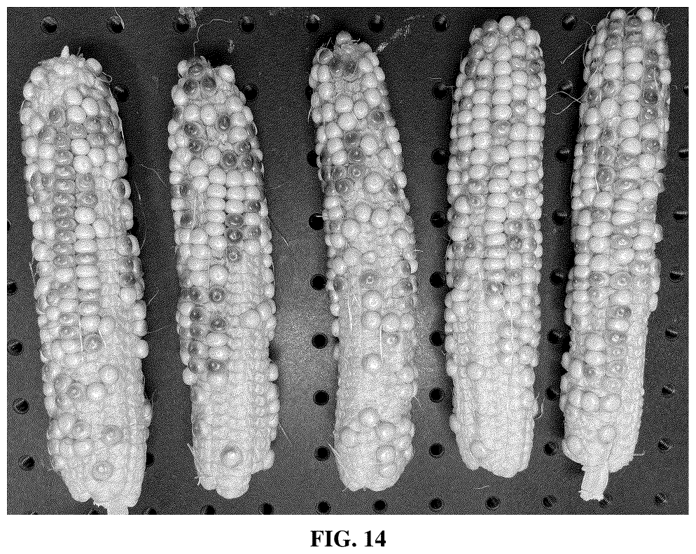

In one such study, the conductive warming apparatus illustrated in FIG. 13 was built and tested. Briefly, the apparatus is comprised of an insulated hopper 16 to keep pollen below the glass transition temperature until the moment of warming, a vibratory feeder 17 whose pan 18 is actively warmed by a foil-type resistive heater 19, and a catch pan 20 to capture thawed pollen. The hopper 16 also has a temperature sensor port 21 in which a temperature sensor is able to monitor the temperature in the hopper. To test the system, approximately 50 g of freshly collected pollen was dried in a fluid bed dryer to a wet-basis moisture content of 21.02%. The entire dried pollen sample was metered directly into liquid nitrogen to freeze and stored for 2 days at −140° C. prior to pollination. After storage, the pollen was withdrawn from storage and immediately transferred to the insulated hopper of the system illustrated in FIG. 13. The vibratory feeder was operated at room temperature until the entirety of the sample had been dispensed. Pollinations were performed using the rapidly thawed pollen. Photographs of the ears obtained when using this conductive thawing system are illustrated in FIG. 14. As can be seen from the photographs, significant seed set was obtained with the thawed pollen illustrating the efficacy of the conductive thawing method.

### Example 10. Additional Systems and Methods for Thawing Cryopreserved Bulk Pollen

Additional systems and methods are provided herein for thawing cryopreserved pollen. One such technique is conductive thawing, which relies on the use of conduction to rapidly warm thin layers of pollen (e.g., heater vibratory feeders). Another approach to thawing bulk pollen samples that may attain rapid and uniform warming rates is through induction. In such systems dried pollen is mixed with a powdered ferromagnetic material prior to freezing. Upon thawing, the systems employ inductive warming to warm the ferromagnetic particles throughout the sample and warm the adjacent pollen grains through induction and convection. Another class of systems for thawing bulk samples of pollen employs electromagnetic waves to warm the samples either in the form of microwaves or infrared radiation. Systems for thawing bulk samples of pollen may also combine the different modes of heat transfer described herein to increase the rates of warming. An additional method for thawing bulk pollen samples entails combining thawing with the application process. In such systems, frozen pollen is directly metered into an airstream and directed towards the stigmas of recipient plants.

Fertile pollen from virtually any plant may be thawed using the systems and methods described herein. Non-limiting examples of which include plants with recalcitrant pollen, dicot plants, monocot plants, cereal plants, Poaceae family plants, Alismataceae family plants, Amaranthaceae family plants, Cactaceae family plants, Chenopodiaceae family plants, Cucurbitaceae family plants, Anacardiaceae family plants, Portulacaceae family plants, Urticaceae family plants, Lauraceae family plants, Liliaceae family plants, Iridaceae family plants, Orchidaceae family plants, Acanthaceae family plants, Caryophyllaceae family plants, corn plants, rice plants, wheat plants, sorghum plants, and canola plants. In specific embodiments, the pollen may be diploid, double haploid, transformed, or pollen collected from a TO transformed plant.

### Example 11. Large Scale Pollen Thawing Assembly

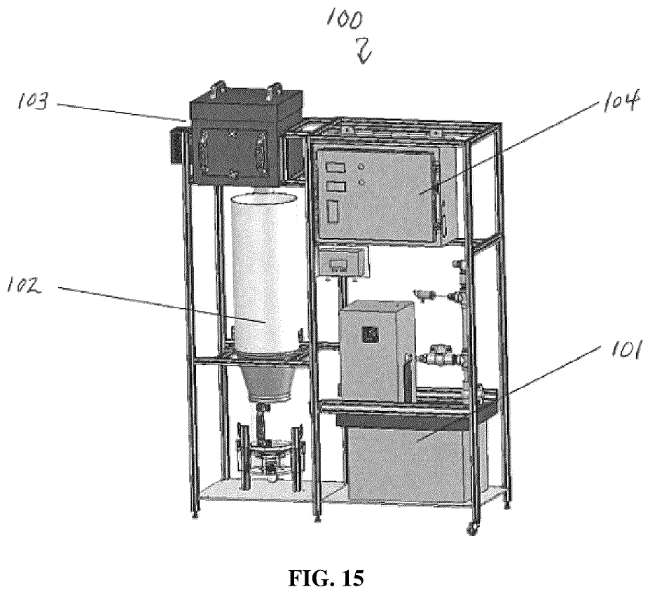

One embodiment of a large scale pollen thawing assembly is shown in FIG. 15. Shown in FIG. 15 is a pollen thawing assembly 100 comprised of a humidification system 101, warming chamber assembly 102, insulated pollen feeder assembly 103, electrical enclosure 104, and associated controls designed to rapidly warm bulk cryopreserved pollen samples ranging from 50 mL-1 L in volume to obtain bulk thawed pollen samples. Briefly, the humidification system 101 generates a stream of warm, humidified air with a specified volumetric flow rate, temperature, and humidity that is passed through the warming chamber assembly 102. The cryopreserved pollen sample is loaded into the insulated pollen feeder assembly 103, which maintains the temperature of the cryopreserved pollen sample below the glass transition temperature of the sample. The feeder dispenses the cryopreserved pollen sample into the warming chamber assembly 102, where the cryopreserved pollen sample is rapidly warmed through convection with the warm, humidified air.

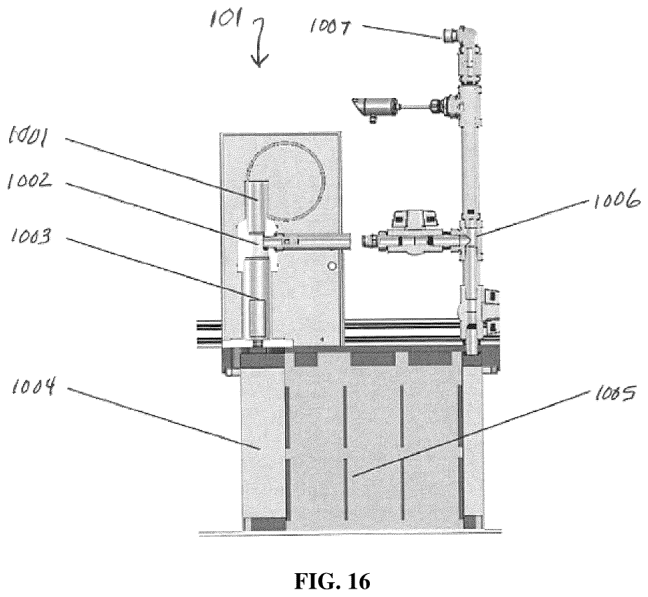

The components of the humidification system 101 of the pollen thawing assembly 100 shown in FIG. 15 are shown in FIG. 16. The humidification system 101 comprises a centrifugal blower 1001, humidifier bypass valve 1002, resistive heating element 1003, humidifier housing 1004, humidifier pads 1005, mixing chamber 1006, and a discharge 1007 that serves to generate a stream of warm, humidified air to rapidly warm pollen. Briefly, the centrifugal blower 1001 pulls air from the ambient environment and pushes it into a humidifier bypass valve 1002 where a variable proportion of the air is directed to a resistive heating element 1003 or a mixing chamber 1006. Air that enters the resistive heating element 1003 is warmed and enters a humidifier housing 1004 filled with water and saturated humidification pads 1005. The warm air passes through the saturated humidifier pads 1005 becoming humidified. After humidification, the warm, humidified air enters a mixing chamber 1006 where it joins with ambient air. The output of the centrifugal blower 1001, output of the resistive heating element 1003, and the bypass ratio are controlled to deliver a precise flow of warm, humidified gas with desired volumetric flow, humidity, and temperature which passes through the discharge 1007 to the warming chamber assembly 102.

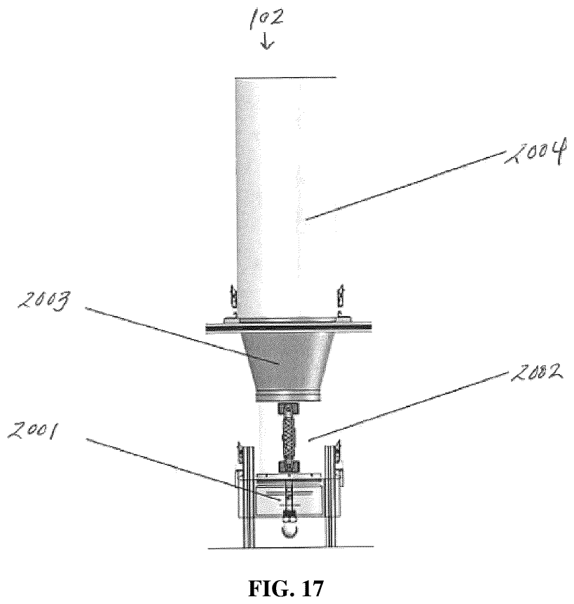

The components of the warming chamber 102 of the pollen thawing assembly 100 shown in FIG. 15 are shown in FIG. 17. The warming chamber assembly 102 of air chambers comprising an air plenum 2001, a collection chamber 2002, a conical reducer 2003, and a settling chamber 2004 through which warm, humidified gas is passed to rapidly warm the cryopreserved pollen sample. Briefly, warm humidified air from the humidifier 101 is conveyed into the air plenum 2001 which distributes flow of the warming gas across the entire cross-sectional area of the collection chamber 2002. The warming gas flows through the collection chamber 2002, conical reducer 2003, and settling chamber 2004 where it ultimately enters the ambient environment. The cryopreserved pollen sample is slowly metered into the settling chamber 2004 where the velocity of warming gas is below the terminal velocity of the pollen sample such that the pollen settles into the conical reducer 2003 and collection chamber 2002 below.

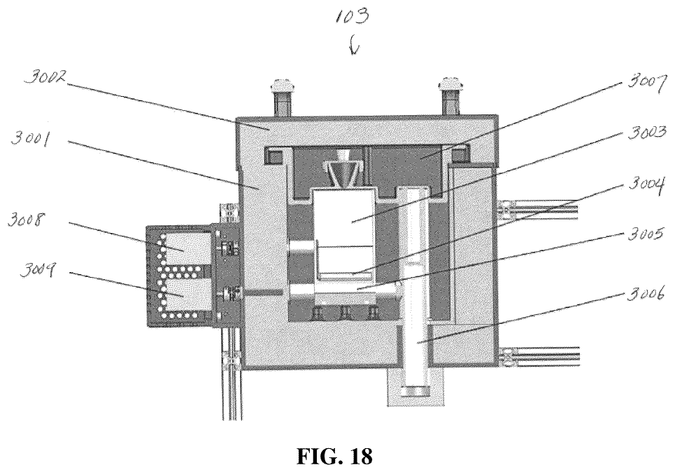

The components of the insulated pollen feeder 103 of the pollen thawing assembly 100 shown in FIG. 15 are shown in FIG. 18. The insulated pollen feeder assembly is comprised of an insulated housing 3001 with removable lid 3002 that houses a hopper 3003, hopper wiper 3004, screw auger 3005, and discharge tube 3006 that are surrounded by a cavity 3007 packed with dry ice. The hopper wiper 3004 and screw auger 3005 are driven by the hopper wiper motor 3008 and screw auger motor 3009, respectively. Briefly, the insulated pollen feeder 103 functions to i) maintain the cryopreserved pollen sample below the glass transition temperature until the moment it is fed into the warming conditions and ii) slowly meter the cryopreserved pollen sample into the warming conditions.

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. For example, all of the disclosed components of the preferred and alternative embodiments are interchangeable providing disclosure herein of many systems having combinations of all the preferred and alternative embodiment components. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims. All such similar substitutes and modifications apparent to those skilled in the art are deemed to be within the spirit, scope and concept of the disclosure as defined by the appended claims.

1. A method of obtaining viable bulk pollen sample after cryogenic storage, comprising:
a) obtaining a cryopreserved bulk pollen sample; and
b) rapidly warming the bulk pollen sample,
wherein each grain of pollen in the bulk pollen sample experiences a warming rate sufficient to prevent ice formation across all sub-freezing temperatures traversed.

2. The method of claim 1, wherein each grain of pollen in the cryopreserved bulk pollen sample experiences a warming rate of greater than 5° C./minute across all sub-freezing temperatures traversed.

3. The method of claim 1, wherein:
al the cryopreserved bulk pollen sample is warmed by convection with a gas or liquid;
b) the cryopreserved bulk pollen sample is warmed by conduction with a gas or liquid;
c) the cryopreserved bulk pollen sample is warmed by contact with an inductively heated material;
d) the cryopreserved bulk pollen sample is warmed by electromagnetic radiation in the microwave or infrared wavelengths; or
e) the cryopreserved bulk sample of pollen is warmed by a combination of convection with a gas or liquid, conduction with a gas or liquid, contact with an inductively heated material or electromagnetic radiation in the microwave or infrared wavelengths.

4.-7. (canceled)

8. The method of claim 1, further comprising the step of:
c) pollinating a plant or population of plants with the thawed pollen.

9. The method of claim 8, wherein the pollinating results in at least 50% seed set.

10. The method of claim 8, further comprising rapidly thawing a plurality of bulk pollen samples.

11. A system for thawing a cryopreserved pollen sample that subjects each pollen grain in the sample to a warming rate exceeding 5° C./min at all subzero temperatures traversed.

12. The system of claim 11, comprising a first chamber to which the cryopreserved pollen sample is introduced and warmed.

13. The system of claim 12, wherein:
a) the first chamber comprises a gas selected from air, nitrogen, oxygen, argon, helium, or a combination thereof that is passed through the cryopreserved pollen sample to convectively warm the cryopreserved pollen sample, creating a thawed pollen sample;
b) the first chamber comprises a liquid to which the cryopreserved pollen sample is introduced to conductively warm the cryopreserved pollen sample creating a thawed pollen sample;
c) the first chamber comprises metallic surface to which the cryopreserved pollen sample is exposed to or conveyed across to conductively warm the sample, creating a thawed pollen sample;
d) the first chamber comprises an inductive heating apparatus in which the cryopreserved pollen sample is mixed with an introduced ferromagnetic material and inductively warmed; or
e) the first chamber comprises electromagnetic radiation to which the cryopreserved pollen sample is exposed to radiatively warm the cryopreserved pollen sample thereby creating a thawed pollen sample.

14. The system of claim 13, further comprising a second chamber in fluid communication with the first chamber, wherein the cryopreserved pollen sample is pneumatically conveyed by the gas through the first chamber to the second chamber, where the pollen settles out of the flow of the gas.

15. The system of claim 14, wherein the gas has been humidified to a level such that the moisture content of the cryopreserved pollen sample is maintained or increased during thawing.

16. (canceled)

17. The system of claim 13 wherein the liquid is an aqueous solution, organic solvent, or an emulsion.

18.-20. (canceled)

21. The system of claim 13, wherein the electromagnetic radiation falls within the microwave or infrared wavelengths.

22. The system of claim 11, further comprising a third container that maintains the cryopreserved pollen sample below the glass transition temperature prior to dispensing the cryopreserved pollen sample into the first chamber.

23. The system of claim 22, wherein the third container comprises a feeding mechanism to meter the cryopreserved pollen sample into the first chamber.

24. The system of claim 23, wherein the feeding mechanism is a screw auger, vibratory feeder, positive displacement feeder, table feeder, belt feeder, or rotary feeder.

25. The system of claim 22, wherein the third container is cooled by dry ice, liquid nitrogen, a mechanical refrigeration system, or a cryocooler.

26. The system of claim 11, wherein:
a) the dry volume of the cryopreserved pollen sample is between about 1 ml and 500 liters;
b) the cryopreserved pollen is from a recalcitrant species; or
c) the moisture content of the cryopreserved pollen sample is between about 10% and 30% wet-basis moisture content.

27. (canceled)

28. The system of claim 26, wherein the pollen is from a Poaceae family plant, an Alismataceae family plant, an Amaranthaceae family plant, a Cactaceae family plant, a Chenopodiaceae family plant, a Cucurbitaceae family plant, a Anacardiaceae family plant, a Portulacaceae family plant, a Urticaceae family plant, a Lauraceae family plant, a Liliaceae family plant, a Iridaceae family plant, a Orchidaceae family plant, a Acanthaceae family plant, or a Caryophyllaceae family plant.

29. The system of claim 26, wherein the pollen is corn, rice, wheat, or sorghum pollen.

30. (canceled)
